(19) United States
(12) Patent Application Publication
(10) Pub. No.: US 2026/0351766 A1
(43) Pub. Date: Nov. 5, 2026

(54) ELECTRIC VEHICLE WITH BATTERY PACK

(71) Applicant: BOMBARDIER RECREATIONAL PRODUCTS INC., Valcourt (CA)

(72) Inventors: Yannick BOURQUE, St-Denis-de-Brompton (CA); Emile MALTAIS-LAROUCHE, Valcourt (CA); Alexandre LECLAIR, Ste-Anne-de-la-Rochelle (CA); Nicolas LABERGE, Magog (CA)

(21) Appl. No.: 19/487,201

(22) PCT Filed: May 28, 2024
(86) PCT No.: PCT/IB2024/055181

§ 371 Date: Nov. 24, 2025

Related U.S. Application Data
(60) Provisional application No. 63/505,159, filed on May 31, 2023.

(51) Int. Cl. H01M 50/249; B60L 50/60; B60L 50/64; B62J 43/16; B62J 43/28; B62K 25/28; H01M 10/613

(52) U.S. Cl. CPC H01M 50/249; B60L 50/64; B60L 50/66; B62J 43/16; B62J 43/28; B62K 25/283; H01M 10/613; B60L 2200/12; B62K 2204/00; H01M 2220/20

(57) ABSTRACT

A vehicle including a battery pack comprising a battery pack housing, the battery pack housing including at least one cooling plate, and at least one pack cover connected to the at least one cooling plate; at least one front wheel rotationally connected to the battery pack housing; at least one rear wheel rotationally connected to the battery pack housing; a straddle seat connected to the battery pack housing; a steering assembly operatively connected to the at least one front wheel; and an electric motor operatively connected to at least one of the at least one front wheel and the at least one rear wheel, the battery pack housing being a structural element of the vehicle for receiving loads from at least one least two of: the at least one front wheel, the at least one rear wheel, the straddle seat, and the steering assembly.

### CROSS-REFERENCE

The present application claims priority to U.S. Provisional Patent Application No. 63/505,159, entitled “Electric Vehicle with Battery Pack,” filed May 31, 2023, the entirety of which is incorporated herein by reference.

### FIELD OF TECHNOLOGY

The present technology relates to staddle seat electric vehicles with battery packs.

### BACKGROUND

Straddle seat vehicles, including motorcycles, all-terrain vehicles, and snowmobiles, are popular transport and recreational vehicles. As the move toward electrification of vehicles progresses, interest in electric versions of straddle seat vehicles increases. Electric vehicles generally include components that are required to be maintained within a specified temperature range, for instance battery packs, inverters, and motors. In some vehicles, cooling is provided through airflow based cooling arrangements.

To better address cooling of each component, some solutions include circulating a liquid coolant around a circuit in thermal communication with the heat-generating components and one or more heat exchangers, such as cooling plates. In order to support the weight of the various electrical components, a frame generally extends along the vehicle, under and around the components. The frame itself adds to the weight of the vehicle, with a compromise often being made between strength of the frame and weight the frame adds to the vehicle, as reducing weight of the vehicle improves battery life.

There is therefore a desire for arrangements of electric straddle seat vehicles addressing at least some of the above described disadvantages.

### SUMMARY

It is an object of the present technology to ameliorate at least some of the inconveniences present in the prior art.

According to aspects of the present technology, there is provided an electric vehicle having a battery pack for both providing electrical power to the motor of the vehicle, with the battery pack housing serving as a structural element of the vehicle, in place of a central frame. Specifically, the cooling plate of the battery pack is configured and arranged to receiving loads from the front wheel, the rear wheel, the seat, and/or the steering assembly. The front wheel and the steering assembly are connected to the cooling plate via a front suspension assembly and a bracket fastened to the cooling plate. The rear wheel is connected to the cooling plate via a rear suspension assembly and a pair of mechanical fuses fastened to the cooling plate. The straddle seat is supported by the cooling plate via a seat frame fastened to and extending upward and rearward from the battery pack.

According to one aspect of the present technology, there is provided a vehicle including a battery pack comprising a battery pack housing, the battery pack housing including at least one cooling plate, and at least one pack cover connected to the at least one cooling plate; at least one front wheel rotationally connected to the battery pack housing; at least one rear wheel rotationally connected to the battery pack housing; a straddle seat connected to the battery pack housing; a steering assembly operatively connected to the at least one front wheel; and an electric motor operatively connected to at least one of the at least one front wheel and the at least one rear wheel, the electric motor being operatively connected to the battery pack for receiving power therefrom, the battery pack housing being a structural element of the vehicle for receiving loads from at least two of: the at least one front wheel, the at least one rear wheel, the straddle seat, and the steering assembly.

In some embodiments, the at least one cooling plate is configured and arranged for receiving loads from at least two of: the at least one front wheel, the at least one rear wheel, the straddle seat, and the steering assembly.

In some embodiments, the vehicle further includes a front suspension bracket connected to and supported by the battery pack housing; and a front suspension assembly connected to and supported by the front suspension bracket, the at least one front wheel being rotationally connected to the front suspension assembly.

In some embodiments, the front suspension bracket includes a head tube; and the front suspension assembly includes a front fork assembly rotationally connected through the head tube.

In some embodiments, the front suspension bracket is fastened to the at least one cooling plate.

In some embodiments, the steering assembly includes a handlebar connected to the front fork assembly; the front fork assembly includes a triple clamp assembly; the triple clamp assembly extends through the head tube; and the handlebar is connected to the triple clamp assembly for steering the vehicle.

In some embodiments, the vehicle further includes a seat frame connected to the battery pack housing, the straddle seat being connected to and supported by the seat frame.

In some embodiments, the seat frame is fastened to the at least one cooling plate.

In some embodiments, the vehicle further includes a rear suspension assembly connected to the battery pack housing, the at least one rear wheel being rotationally connected to the rear suspension assembly.

In some embodiments, the vehicle further includes at least one rear bracket connected to the battery pack housing, at least a portion of the rear suspension assembly being pivotally connected to the at least one rear bracket.

In some embodiments, the at least one rear bracket includes at least one rear mechanical fuse.

In some embodiments, the vehicle further includes a front suspension bracket connected to and supported by the battery pack housing; and a front suspension assembly connected to and supported by the front suspension bracket, the at least one front wheel being rotationally connected to the front suspension assembly.

In some embodiments, the battery pack housing is a sole structural connection between the front suspension assembly and the rear suspension assembly.

In some embodiments, the battery pack housing connects the front suspension assembly to the rear suspension assembly.

In some embodiments, the rear suspension assembly includes a swing arm pivotally connected to the battery pack housing; and a shock absorber pivotally connected to the swing arm at a first end, a second end of the shock absorber being pivotally connected to the battery pack housing.

In some embodiments, the vehicle further includes at least one shock bracket fastened to the at least one cooling plate, the second end of the shock absorber being pivotally connected to the at least one shock bracket.

In some embodiments, the at least one shock bracket is at least one shock mechanical fuse.

In some embodiments, the vehicle further includes at least one rear bracket connected to the battery pack housing, a front end of the swing arm being pivotally connected to the at least one rear bracket.

In some embodiments, the at least one rear bracket includes: a left rear mechanical fuse at least partially disposed on a left side of the battery pack housing, and a right rear mechanical fuse at least partially disposed on a right side of the battery pack housing; a left side of the swing arm is connected to the left rear mechanical fuse; and a right side of the swing arm is connected to the right rear mechanical fuse.

In some embodiments, the at least one rear bracket includes at least one mechanical fuse, and the motor is disposed in the swing arm, the motor being supported by the battery pack housing via the at least one rear mechanical fuse.

In some embodiments, the vehicle further includes a seat frame connected to the battery pack housing and the at least one rear bracket, the straddle seat being connected to and supported by the seat frame.

In some embodiments, the at least one rear mechanical fuse includes: a left rear mechanical fuse at least partially disposed on a left side of the battery pack housing, and a right rear mechanical fuse at least partially disposed on a right side of the battery pack housing; the seat frame includes: a left seat frame portion, and a right seat frame portion; the left seat frame portion is connected to the left rear mechanical fuse; and the right seat frame portion is connected to the right rear mechanical fuse.

In some embodiments, the at least one cooling plate includes a first cooling plate portion and a second cooling plate portion connected together; and at least one cooling channel is defined between the first cooling plate portion and the second cooling plate portion, the at least one cooling channel being configured to receive therein a coolant fluid.

In some embodiments, the at least one pack cover includes: a first cover connected to the first cooling plate portion; and a second cover connected to the second cooling plate portion.

In some embodiments, the vehicle further includes a fluid cooling system including: a fluid pump; a coolant fluid reservoir; and a cooling circuit formed at least in part by the at least one cooling channel of the battery pack housing, the at least one cooling channel being fluidly connected to the fluid pump and the coolant fluid reservoir.

In some embodiments, the battery pack further comprises a plurality of battery cells disposed in the battery pack housing, the plurality of battery cells being disposed in thermal communication with the at least one cooling plate.

In some embodiments, a top most point of the battery pack housing is vertically higher than the at least one front wheel and the at least one rear wheel; and a bottom most point of the battery pack housing is vertically lower than a rotation axis of the at least one front wheel and a rotation axis of the at least one rear wheel.

In some embodiments, the battery pack housing is disposed longitudinally between the at least one front wheel and the at least one rear wheel.

For the purposes of the present application, terms related to spatial orientation such as forward, rearward, front, rear, upper, lower, left, and right, are as they would normally be understood by a driver of the vehicle sitting thereon in a normal driving position with the vehicle being upright and steered in a straight ahead direction.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of embodiments of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a left side elevation view of a vehicle according to non-limiting embodiments of the present technology;

FIG. 2 is a right side elevation view of the vehicle of FIG. 1;

FIG. 3 is a top plan view of the vehicle of FIG. 1;

FIG. 4 is a left side elevation view of the vehicle of FIG. 1, with some exterior portions removed;

FIG. 5 is a right side elevation view of the vehicle of FIG. 1, with some exterior portions removed;

FIG. 6 is a partially exploded, top, rear, right side perspective view of a powerpack of the vehicle of FIG. 1;

FIG. 7 is an exploded, top, rear, right side perspective view of a battery pack housing of the powerpack of FIG. 6, with internal components of the battery pack having been removed;

FIG. 8 is a partially exploded, top, rear, right side perspective view of the battery pack of the powerpack of the vehicle of FIG. 6;

FIG. 9 is a top, rear, left side perspective view of the battery pack of FIG. 6, with covers of the battery pack housing having been removed;

FIG. 10 is a left side elevation view of the vehicle of FIG. 1, with some exterior portions removed and covers and electronic portions of the battery pack removed;

FIG. 11 is a left side elevation view of the vehicle portions of FIG. 10, with the battery pack housing portions further being removed;

FIG. 12 is a partial, close-up, rear, left side perspective view of forward portions of the vehicle as illustrated in FIG. 4;

FIG. 13 is a partial, close-up, top, left side perspective view of central portions of the vehicle as illustrated in FIG. 10;

FIG. 14 is a cross-sectional view of the forward vehicle portions of FIG. 12, taken through a cooling plate of the battery pack;

FIG. 15 is a partial, close-up, rear, left side perspective view of upper, rear portions of the vehicle as illustrated in FIG. 4;

FIG. 16 is a partial, close-up, rear, left side perspective view of central portions of the vehicle as illustrated in FIG. 4;

FIG. 17 is a cross-sectional, front, left side perspective view of central vehicle portions of FIG. 16, taken through the cooling plate of the battery pack;

FIG. 18 is a cross-sectional, front, left side perspective view of central vehicle portions of FIG. 16, taken through the cooling plate of the battery pack; and

FIG. 19 is a close-up, partial, rear, left side perspective view of upper, rear portions of the vehicle as illustrated in FIG. 10.

It should be noted that, unless otherwise explicitly specified herein, the drawings are not necessarily to scale.

### DETAILED DESCRIPTION

The present technology will be described herein with respect to a straddle-seat electric vehicles, specifically a two-wheeled electric motorcycle 100. Aspects of the present technology could also be implemented in different straddle-seat electric vehicles, such as three-wheeled electric vehicles.

While the motorcycle 100 illustrated herein is a street style electric motorcycle 100, it is contemplated that motorcycles according to the present technology could vary by a plurality of vehicle characteristics. These vehicle characteristics could include, but are not limited to, a rider posture configuration (also referred to as a rider position), a motorcycle type, tire type, a wheelbase, a steering arrangement, a weight distribution, a squat ratio, a rake angle, a seat height, and a mechanical trail. The rider posture configuration, or rider position, is the relative spacing and position of a rider's hands (when holding the handlebars), the rider's feet (when positioned on the footrests) and the rider's buttocks (when the rider is seated on a seat of the motorcycle). The steering arrangement could also vary and can be described by a variety of parameters, including but not limited to: a length of front suspension travel, a length of rear suspension travel, a front suspension stiffness, a rear suspension stiffness, a front and/or rear wheel size, rake angle, mechanical trail, triple clamp offset, squat ratio, and wheel base.

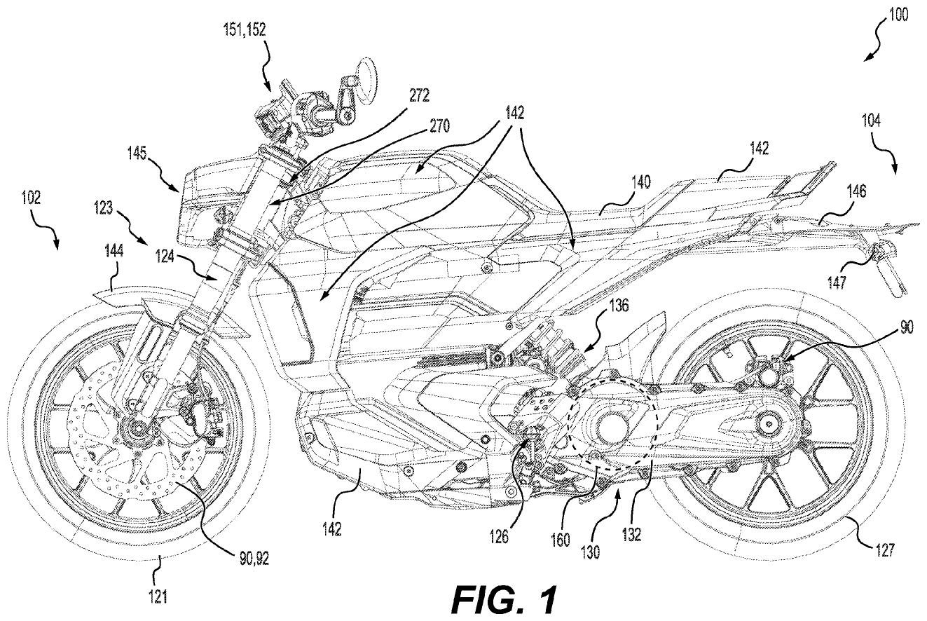

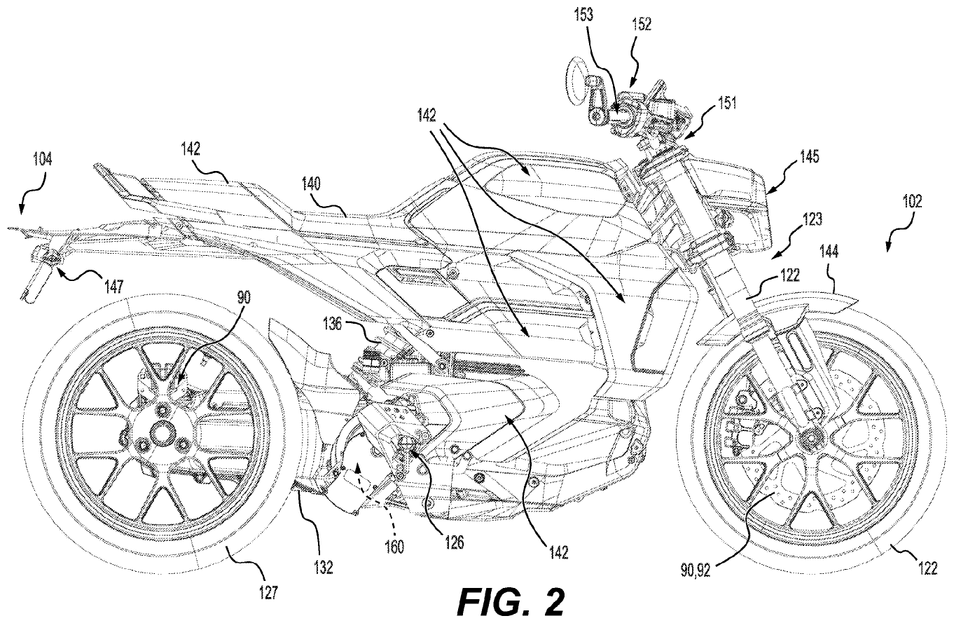

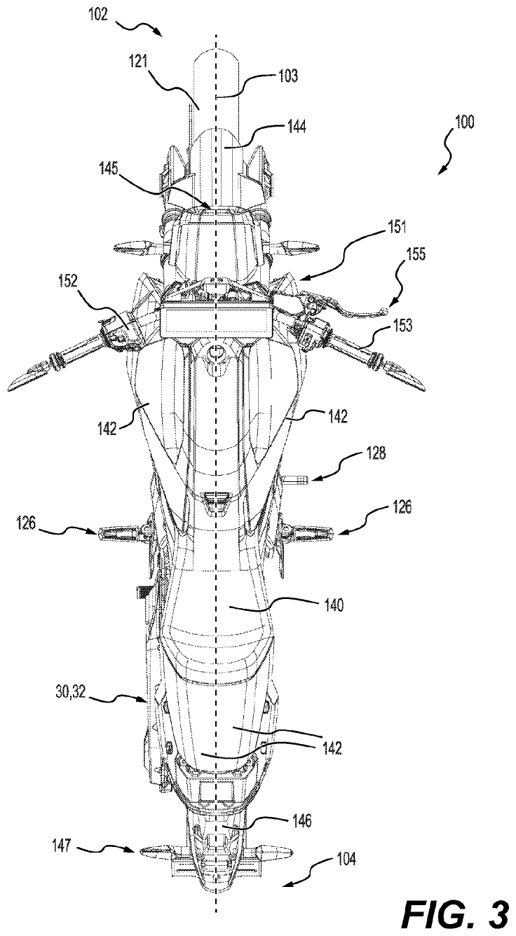

With reference to FIGS. 1 to 3, the electric motorcycle 100, referred to herein as the vehicle 100, has a front end 102, a rear end 104, and a longitudinal centerplane 103 defined consistently with the forward travel direction of the vehicle 100. The vehicle 100 is a two-wheeled vehicle 100 including a front wheel 121 and a rear wheel 127. The front wheel 121 and the rear wheel 127 each have a tire secured thereto. The front wheel 121 and the rear wheel 127 are centered with respect to the longitudinal centerplane 103.

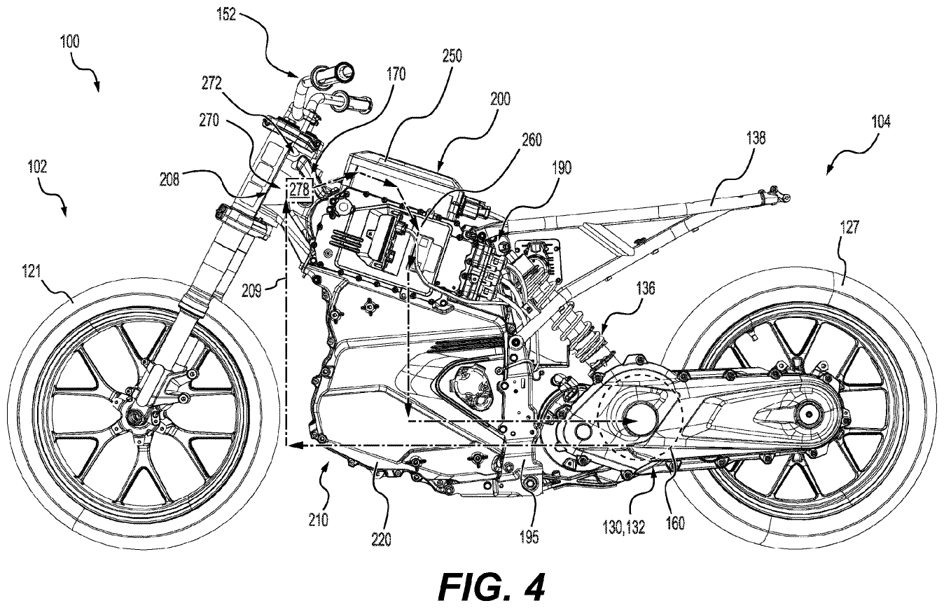

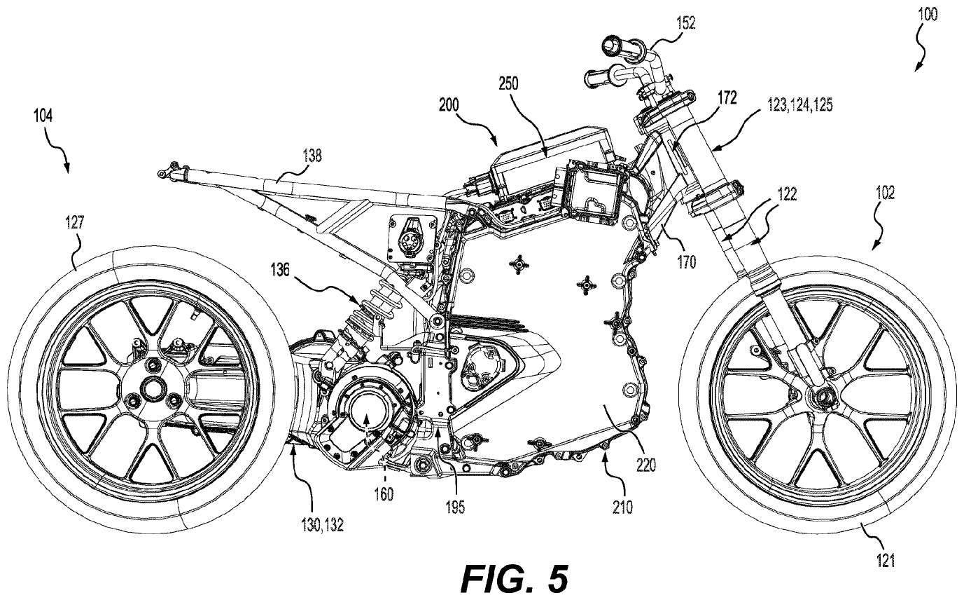

With reference to FIGS. 4 to 6, the vehicle 100 includes an electronic powerpack 200 for powering the vehicle 100. The powerpack 200 includes a battery pack 210, a charger 250, and an inverter 260; each will be described in more detail below.

Also referred to as an energy storage system (ESS) or battery energy storage system (BESS), the battery pack 210 includes a battery pack housing 220, referred to herein as the housing 220. The battery pack 210 is arranged in the vehicle 100 such that the battery pack 210 and the battery pack housing 220 are disposed longitudinally between the front wheel 121 and the rear wheel 127. A top most point of the battery pack 210 and the battery pack housing 220 are vertically higher than the front wheel 121 and the rear wheel 127. A bottom most point of the battery pack 210 and the battery pack housing 220 are vertically lower than a rotation axis of the front wheel 121 and a rotation axis of the rear wheel 127.

According to the present technology, portions of the battery pack 210, specifically the housing 220 thereof, provide structure for the vehicle 100 in place of a central frame. The battery housing 220 is arranged and configured for receiving loads from the front wheel 121, the rear wheel 127, a straddle seat 140 of the vehicle 100, and/or a steering assembly 151 of the vehicle 100. Connections and arrangement of the housing 220 for providing structure to the vehicle 100 are described in additional detail below.

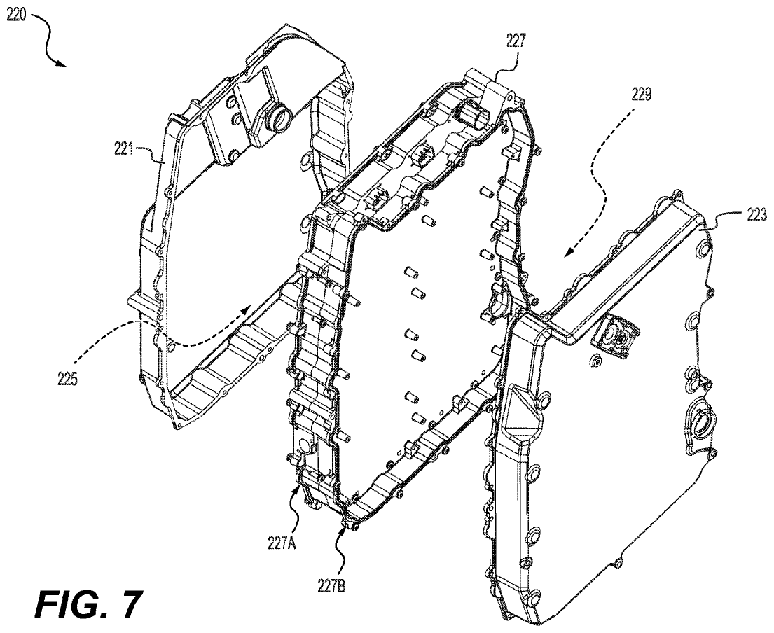

The battery pack 210 is illustrated in additional detail in FIGS. 7 to 9. The battery housing 220 includes a cooling plate 227, also referred to as a main housing body 227, forming a center portion of the housing 220. The battery housing 220 also includes a left side cover 221 and a right side cover 223 selectively connected to the plate 227. Each cover 221, 223 is selectively fastened to the housing body 227 to encase additional components of the battery pack 210 therein. It is contemplated that the covers 221, 223 could be selectively connected to the housing body 227 in different manners, including for example by tabs. A left chamber 225 is formed between the center portion of the housing body 227 and the left cover 221. A right chamber 229 is formed between the center portion of the housing body 227 and the right cover 223. The left and right chambers 225, 229 are illustrated in the exploded view of FIG. 7.

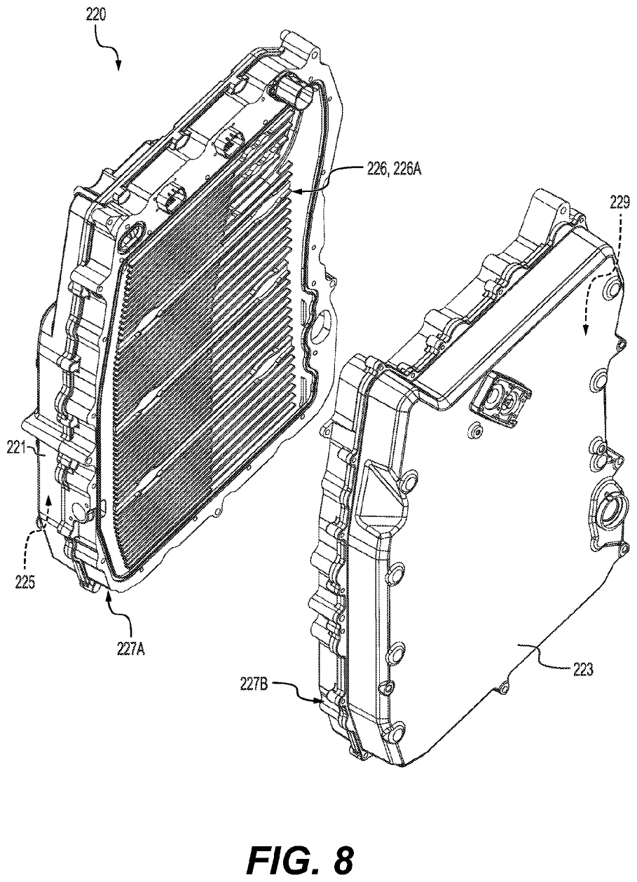

As is illustrated in FIG. 8, the cooling plate 227 includes a left cooling plate portion 227A and a right cooling plate portion 227B connected together to form the cooling plate 227. In the illustrated embodiment the left and right cooling plate portions 227A, 227B are selectively connected together via threaded fasteners (not shown). It is contemplated that the left and right cooling plate portions 227A, 227B could be otherwise connected together in different manners. It is also contemplated that the cooling plate 227 could be integrally formed in some embodiments. In the present embodiment, the cooling plate 227 is formed from aluminum, but could be formed from different materials, including but not limited to various metals and carbon fiber. The left side cover 221 is selectively connected to the left lateral portion 227A and the right side cover 223 is selectively connected to the right lateral portion 227B.

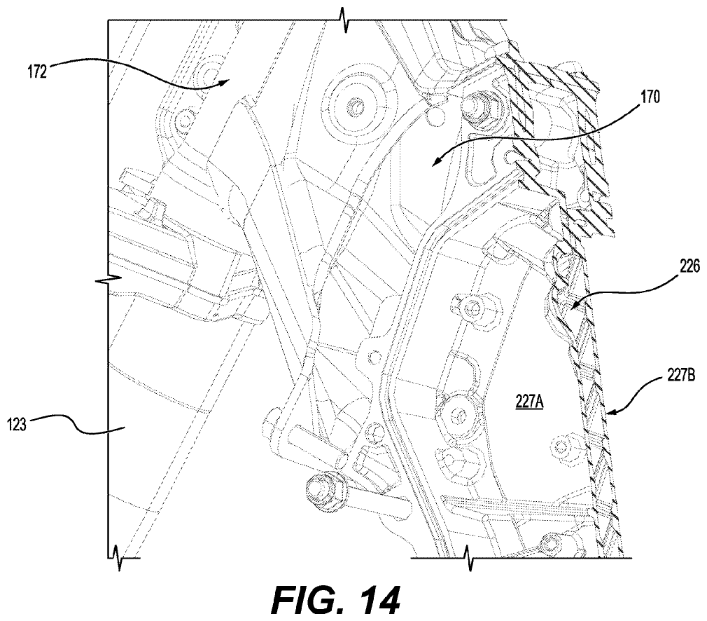

The housing 220 defines a battery cooling channel 226 therein, specifically through a center portion of the cooling plate 227. As can be seen in FIG. 8 as well as FIG. 14, the battery cooling channel 226 includes a plurality of fins extending inward from the cooling plate 227 and coolant fluid flows along a longitudinal direction through a center of the cooling plate 227, along the direction of the centerplane 103, as well as along a vertical/lateral plane of the vehicle 100 (orthogonal to the centerplane 103), descending toward a cooling channel outlet (not shown). An inner face of the left lateral portion 227A includes a first channel form 226A (FIG. 8) formed thereon and an inner face of the right lateral portion 227B includes a second channel form 226B (FIG. 14) formed thereon. The cooling channel 226 is defined by the space created between the first and second channel forms 226A, 226B of the inner faces of the left and right lateral portions 227A, 227B. The battery cooling channel 226 forms a portion of a cooling path 209 (see FIG. 4) for cooling at least some heat producing components of the vehicle 100, described in more detail below.

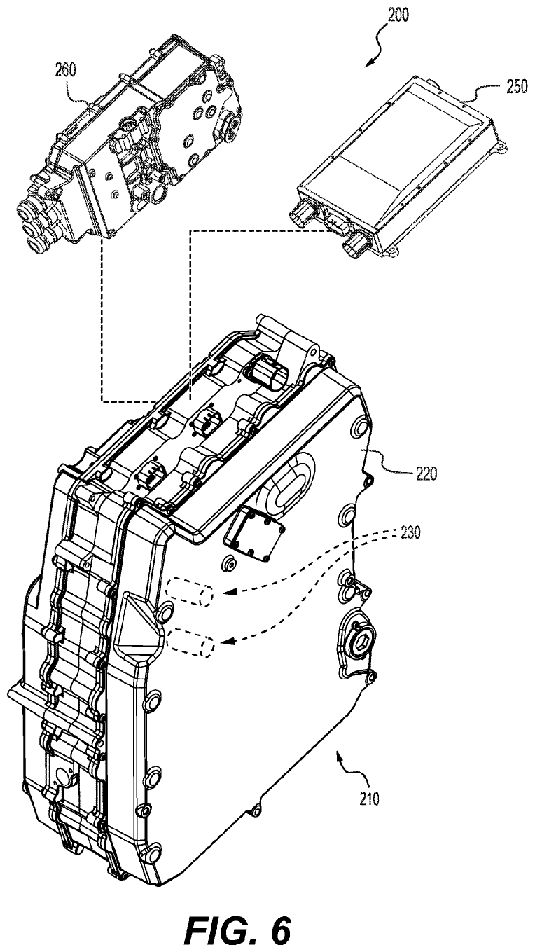

The battery pack 210 includes a plurality of battery cells 230 housed in the battery housing 220, two battery cells 230 being schematically illustrated in FIG. 6. The battery cells 230 are cylindrical battery cells 230. In the present embodiment, the battery cells 230 are 3.6V cylindrical cells, such as LG™ M50L lithium-ion cells in 21700 format, but it is contemplated that different versions of cells could be used in some embodiments. Depending on the particular implementational details of a given embodiment of the vehicle 100, the specific implementation details of the battery pack 210 and/or the plurality of battery cells 230 could vary. For example, battery cells could vary in nominal energy capacity, usable energy capacity, discharge rate, cell chemistry and cell type.

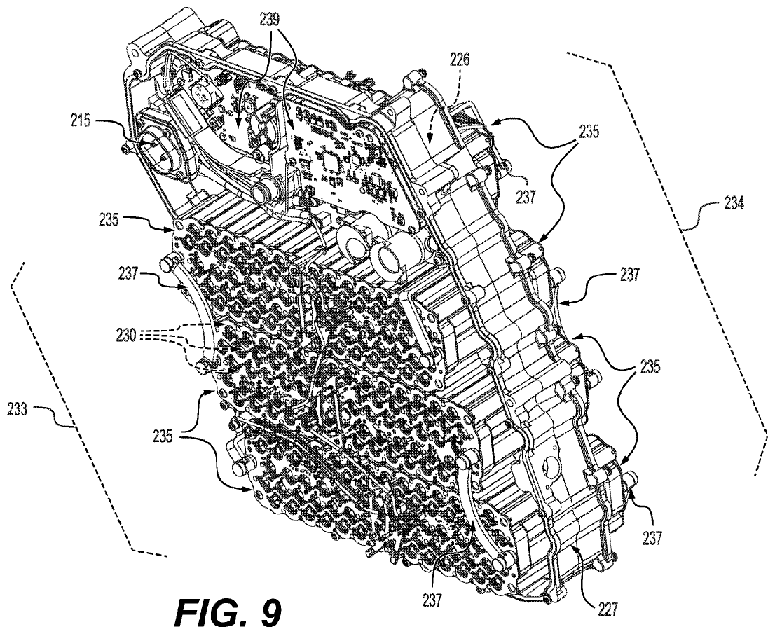

As can be seen in FIG. 9, the battery cells 230 are arranged into a plurality of battery modules 235, also referred to as bricks 235. In the present embodiment, the battery pack 210 includes seven battery modules 235 of seventy battery cells 230 each. The battery pack 210 thus has a total of 490 battery cells 230. It is contemplated that each battery module 235 could include more or fewer battery cells 230 and/or the battery pack 210 could have more or fewer modules 235. Depending on the number of battery cells 230 in each module 235 and/or the total number of modules 235 in a given embodiment, it is also contemplated that the total number of battery cells 230 in the battery pack 200 could vary.

The battery modules 235 are separated into two banks of modules: a left bank 233 having three modules 235 disposed in the left chamber 225, and a right bank 234 having four modules 235 disposed in the right chamber 229. Depending on the embodiment, the left and right banks 233, 234 of modules 235 could include more or fewer modules 235. It is also contemplated that the left and right banks 233, 234 could have equal numbers of modules 235. The left bank 233 has more modules 235 than the right bank 234 in the present embodiment, but it is contemplated that the right bank 234 could have more modules 235 than the left bank 233. Each bank 233, 234 of modules 235 is electrically connected together in series by a plurality of bus bars 237.

As can be seen in FIG. 9, the battery pack 210 further includes battery management electronics 239 operatively connected to the modules 235. Different methods and arrangements of battery cell management could be used in different embodiments and are not meant to be specifically limited to the presently illustrated embodiment.

Returning to FIGS. 4 to 6, the powerpack 200 also includes a charger 250 connected to the battery pack 210, and more specifically electrically connected to the battery cells 230 for supplying charge to the battery cells 230. The charger 250 is fastened to the battery housing 220 and is disposed on a top side of the battery housing 220. It is contemplated that the location of the charger 250 relative to the battery pack 210 could vary.

The powerpack 200 further includes an inverter 260 disposed on a left side of the battery pack 210 and specifically fastened to the battery housing 220. As such, the inverter 260 is mounted to the battery housing 220. In some embodiments, it is contemplated that the inverter 260 could be disposed on a different side of the battery pack 210.

The vehicle 100 further includes an electric motor 160 for driving the vehicle 100, specifically the rear wheel 127. The vehicle 100 includes a swing arm 132, with the rear wheel 127 being rotationally connected to the swing arm 132; the swing arm 132 and the overall rear suspension arrangement will be described in more detail below. The motor 160 is disposed in the swing arm 132 in the present embodiment. It is contemplated that the motor 160 could be differently arranged in some embodiments. Electric power is provided to the motor 160 by the electronic powerpack 200, the motor 160 being operatively connected to the battery pack 210. The motor 160 drives the rear wheel 127 via a transmission assembly (not shown) disposed in the swing arm 132. In the present embodiment, the motor 160 is a three-phase electric motor 160. It is contemplated that different types of motors could be used in some embodiments.

According to non-limiting embodiments of the present technology, the vehicle 100 includes a cooling system 208 for cooling electronic components of the vehicle, including the powerpack 200 and the motor 160. The cooling system 208 is formed in part by a cooling circuit 209, illustrated schematically in FIG. 4. The cooling circuit 209 is in the form of a closed fluid cooling loop 209 for absorbing heat from the motor 160 and components of the powerpack 200. Heat transfer in the cooling circuit 209 is provided by a liquid coolant, generally a glycol-water coolant, although it is contemplated that different liquid coolants could be utilized. It is noted that while liquid coolant is provided, some gases may also be present in the cooling circuit 209, due to phase transitions or air infiltrations.

In some embodiments, it is contemplated that the cooling circuit 209 could be limited to the powerpack 200 and cooling of the motor 160 could be provided by other means. It is also contemplated that some components of the powerpack 200 could be omitted from the cooling circuit 209 and cooling could be provided by other means. For example, some components of the vehicle 100 could be cooled through air cooling.

The cooling system 208 includes a coolant reservoir 270 (FIGS. 1 and 4) connected to the powerpack 200 and fluidly connected to the cooing circuit 209. The reservoir 270 is disposed partially forward of the powerpack 200. It is contemplated that the exact positioning of the reservoir 270 could vary in different embodiments.

The reservoir 270 receives liquid coolant therein and supplies coolant to the cooling circuit 209. It is noted that the cooling circuit 209 is considered a “closed loop” in that the coolant flowing through the cooling circuit 209 absorbs heat from heat-generating components and radiates that heat away using heat exchangers without exchanging the coolant fluids. The reservoir 270 includes a reservoir cap 272 selectively connected thereto. The reservoir 270 provides for coolant to be refilled or supplemented if necessary. When the cap 272 is removed, additional coolant fluid can be added to the reservoir 270 to supplement the fluid level of coolant in the cooling circuit 209. It is contemplated that the coolant reservoir 270 could be omitted in some embodiments and that coolant fluid could be added elsewhere in the cooling circuit 209.

The cooling system 208 also includes a coolant pump 278 (shown schematically) for circulating cooling through and forming a portion of the cooling circuit 209. In the illustrated embodiment, the coolant pump 278 is electrically connected to the battery pack 210 for powering the pump 278. It is contemplated that placement of the pump 278 could vary. The vehicle 100 includes a radiator (not shown) for cooling the coolant fluid. More radiators or different arrangements for cooling the coolant fluid are contemplated.

Flow of the cooling circuit 209 is schematically illustrated in FIG. 4. Beginning at the coolant reservoir 270 (for simplicity of description), coolant is pumped from the reservoir 270 into the charger 250, specifically a cooling channel defined therein (not shown). Coolant then flows through an inverter cooling channel (not shown) of the inverter 260 and then subsequently into the battery cooling channel 226.

As described above, the battery cooling channel 226 extends through a center portion of the battery pack 210, in the interior of the powerpack 200. Coolant fluid flows along a longitudinal direction through the cooling plate 227, along the direction of the centerplane 103, as well as along a vertical/lateral plane of the vehicle 100 (orthogonal to the centerplane 103). By being disposed in the center portion 227 of the housing 220, the channel 226 is in thermal communication with banks of battery cells 230 disposed on both a right side of the channel 226 and a left side of the channel 226.

From the battery cooling channel 226, coolant flows through a flexible tube (not shown) to a motor cooling channel (not shown) of the motor 160. Coolant is then subsequently returned to forward portions of the vehicle 100 via tubes (not shown) on each of the right and left sides of the vehicle 100 to the radiators. Having been at least partially cooled, coolant is then returned to the reservoir 270. The direction of coolant flow could be reversed in at least some embodiments. The order of some components forming the cooling circuit 209 could be changed in some embodiments.

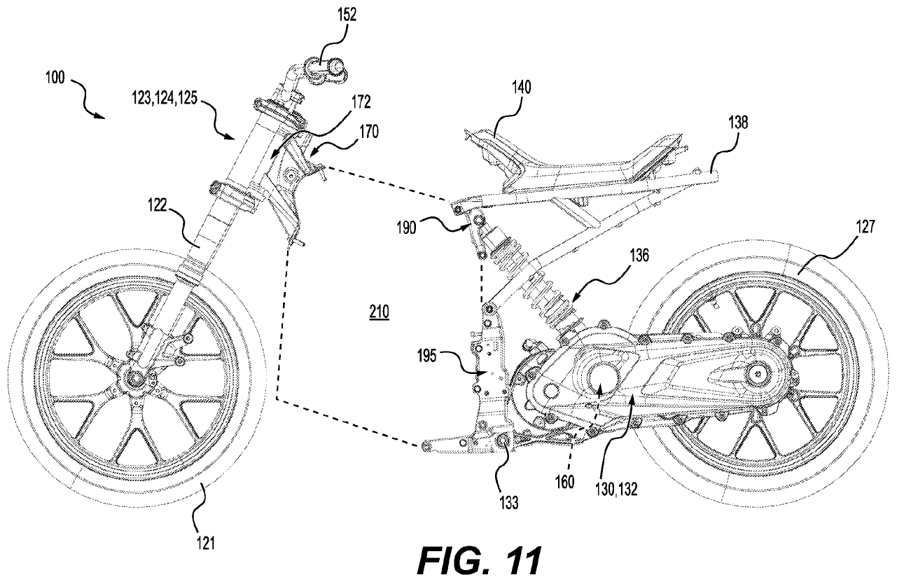

According to the present technology, the battery pack housing 220 is a structural element of the vehicle 100 for receiving loads from two or more of the front wheel 121, the rear wheel 127, the straddle seat 140, and the steering assembly 151, as is mentioned briefly above. Specifically, the cooling plate 227 is configured and arranged for receiving the loads from the front wheel 121, the rear wheel 127, the straddle seat 140, and/or the steering assembly 151. See for instance FIG. 11, where the vehicle 100 is illustrated with the battery pack 210 removed, illustrating that it is only the battery pack 210 providing a structural connection between forward portions of the vehicle 100 and rear portions thereof. The vehicle 100 does not include a central frame. The vehicle 100 thus includes a variety of brackets and assemblies for connecting forward and rear components of the vehicle 100 to the battery pack housing 220.

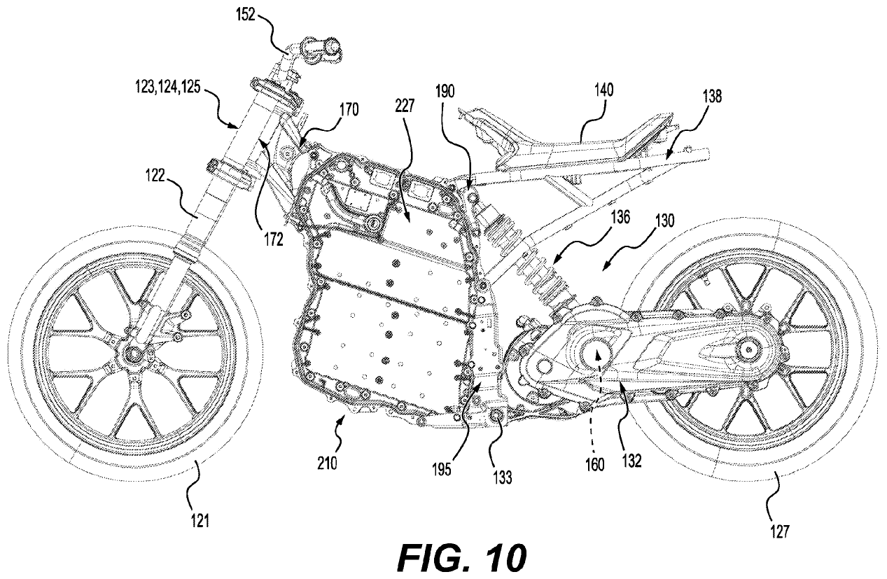

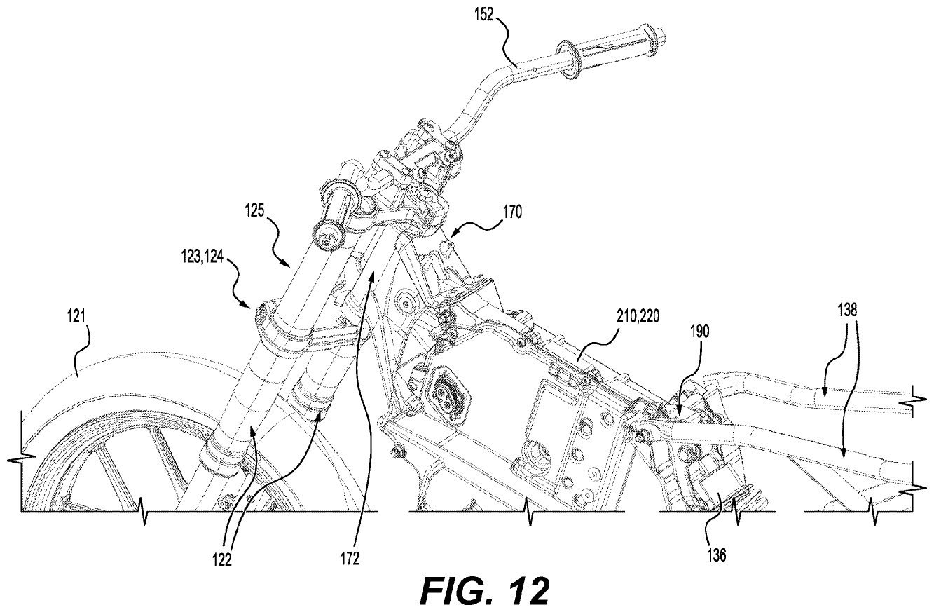

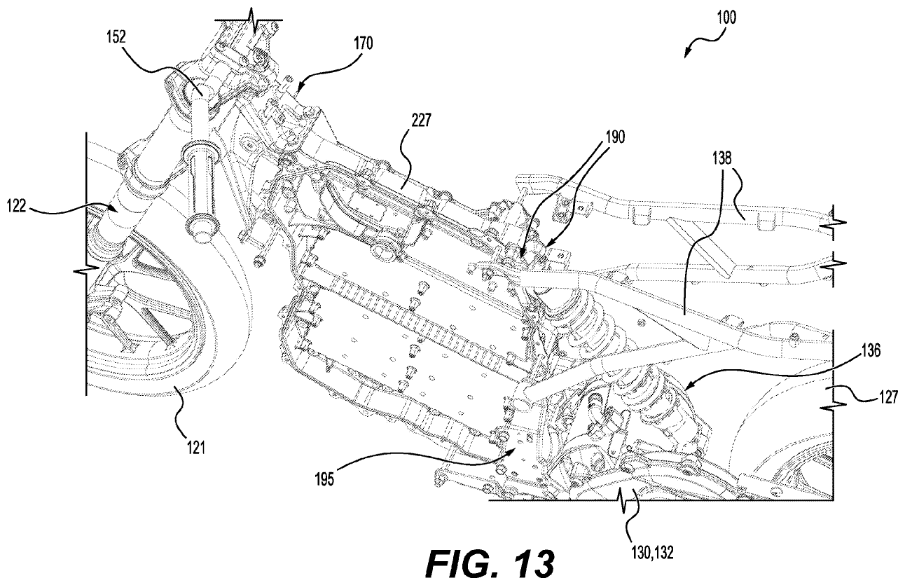

With continued reference to FIGS. 1 to 5, and with additional reference to FIGS. 10 to 14, the vehicle 100 includes a front suspension bracket 170 connected to and supported by the battery pack housing 220 for supporting the front wheel 121. As such, the front wheel 121 is supported by the battery pack housing 220 via the front suspension bracket 170. As can be seen in FIGS. 13 and 14, the front suspension bracket 170 is specifically fastened to the cooling plate 227.

The front wheel 121 is connected to the bracket 170 by a front suspension assembly 123, the front wheel 121 being rotationally connected to the front suspension assembly 123. The front suspension assembly 123 includes a front fork assembly 124 for supporting the front end 102 of the vehicle 100. The front fork assembly 124 includes a triple clamp assembly 125. The front fork assembly 124 also includes a pair of front shocks 122 connected to the triple clamp assembly 125. The front wheel 121 of the front fork assembly 124 is connected to a bottom portion of the pair of front shocks 122.

The front suspension bracket 170 includes a front suspension receiving portion 172, specifically a tube 172, sometimes referred to as a “head tube” 172. The front fork assembly 124 is rotationally connected through the head tube 172, such that the front suspension assembly 123 is supported, but permitted to rotate within, the front suspension bracket 170.

The vehicle 100 includes a handlebar assembly 152 operatively connected to the front fork assembly 124. The handlebar assembly 152 forms a portion of a steering assembly 151 and is used by the rider to turn the front wheel 121, via the front fork assembly 124, to steer the vehicle 100. Specifically, the handlebar assembly 152 is connected to a top end of the triple clamp assembly 125. The handlebar assembly 152 and the triple clamp assembly 125 define a steering axis about which the front wheel 121 turns to steer the vehicle 100. A twist-grip throttle 153 is operatively connected on the right side of the handlebar assembly 152 for controlling vehicle speed. It is contemplated that the twist-grip throttle 153 could be replaced by a thumb throttle lever or some other type of throttle input device. The twist-grip throttle 153 could be disposed on the left side of the handlebar assembly 152 in some embodiments. The handlebar assembly 152 also includes a brake lever 155 on a right side for activating the brake assemblies 90.

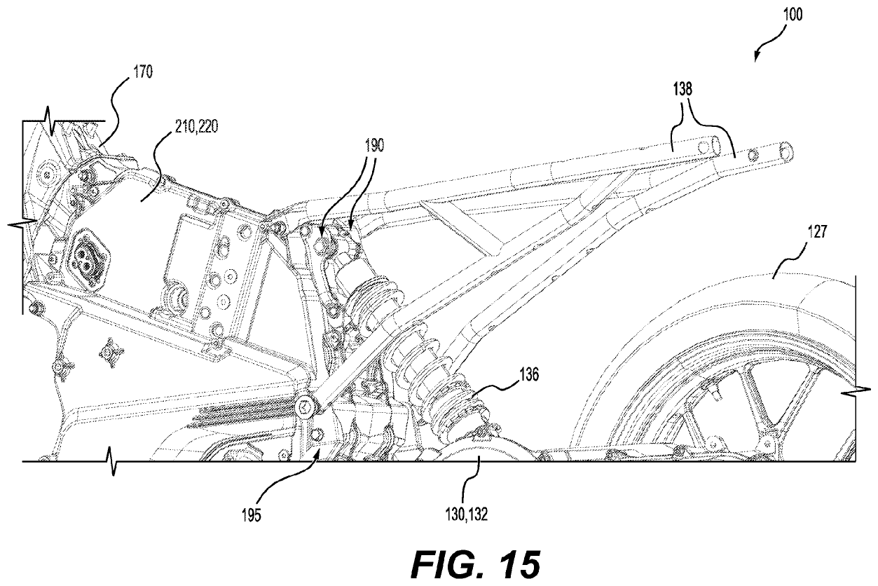

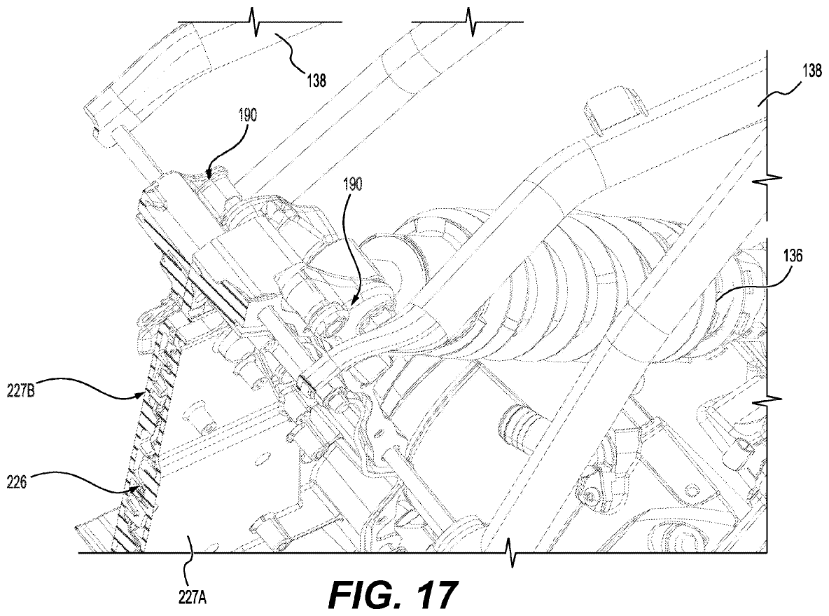

Returning to FIGS. 1 to 3, 10, and 11, the vehicle 100 includes a straddle seat 140 disposed along the longitudinal centerplane 103. The straddle seat 140 is connected to and supported by the battery pack 210. Specifically, the vehicle 100 includes a seat frame 138 connected to the battery pack housing 220; see additionally FIGS. 15 to 17. The straddle seat 140 in turn is connected to and supported by the seat frame 138. As can be seen in FIGS. 10 and 13, upper portions of the seat frame 138 are fastened directly to the cooling plate 227. While the seat frame 138 is illustrated as being formed from two separate rigid member assemblies in the present embodiment, it is contemplated that the seat frame 138 could be one integrally connected structure or formed from more than two structures.

In the illustrated implementation, the straddle seat 140 is intended to accommodate a single adult-sized rider, i.e. the driver. It is however contemplated that the seat 140 could be longer or that a passenger seat portion could be connected to the seat frame 138 in order to accommodate a passenger behind the driver. Depending on the particular implementation, it is also contemplated that the seat 140 could be supported by body panels of the vehicle 100.

With additional reference to FIGS. 15 to 19, the vehicle 100 also includes a rear suspension assembly 130. The rear suspension assembly 130 includes the swing arm 132 and a shock absorber 136. As is mentioned above, the motor 160 and a drivetrain connecting the motor 160 to the rear wheel 127 are disposed in the swing arm 132. The swing arm 132 is pivotally mounted at a front thereof to the battery pack 210. The rear wheel 127 is rotatably mounted to the rear end of the swing arm 132 which extends on a left side of the rear wheel 127. The shock absorber 136 is connected between the swing arm 132 and the battery pack 210. It is contemplated that the relative arrangement of the shock absorber 136 and the rear wheel 127 to the swing arm 132 could vary in different embodiments.

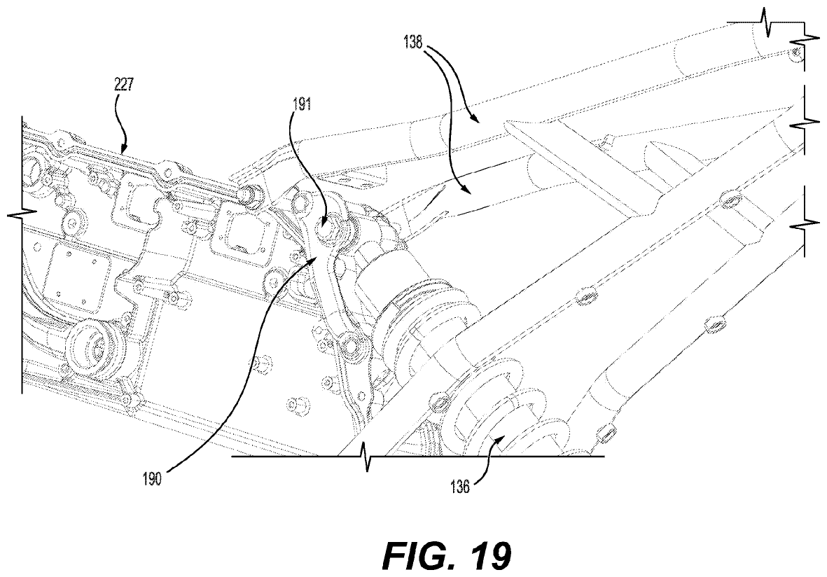

As is illustrated in FIGS. 15 to 19, the vehicle 100 includes brackets connecting the rear suspension assembly 130 to the battery pack 210, the brackets further acting as a plurality of mechanical fuses as will be described further below. Specifically, the vehicle 100 includes two shock brackets 190 connecting the shock absorber 136 to the cooling plate 227 (see FIG. 19). A left shock bracket 190, also referred to as the left shock mechanical fuse 190, is fastened to the left cooling plate portion 227A. A right shock bracket 190, also referred to as the right shock mechanical fuse 190 is fastened to the right cooling plate portion 227B. An upper end 137 of the shock absorber 136 is pivotally connected between the left and right brackets 190, such that the shock absorber 136 is pivotally connected to the battery pack 210. In the present embodiment, a fastener 191 (specifically a bolt 191) extends through the left bracket 190, the upper end 137, and the right bracket 190. Upper and lower ends of the shock mechanical brackets 190 are fastened to the cooling plate 227. In some embodiments, it is contemplated that portions of the brackets 190 could be connected to other parts of the battery pack housing 220, for examples to the covers 221, 223. It is also contemplated that one shock bracket 190 could be used in some embodiments.

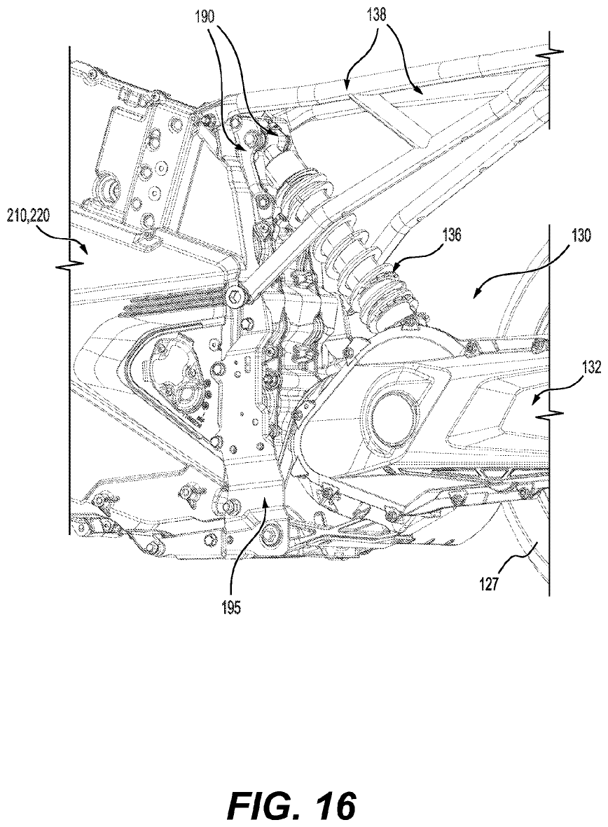

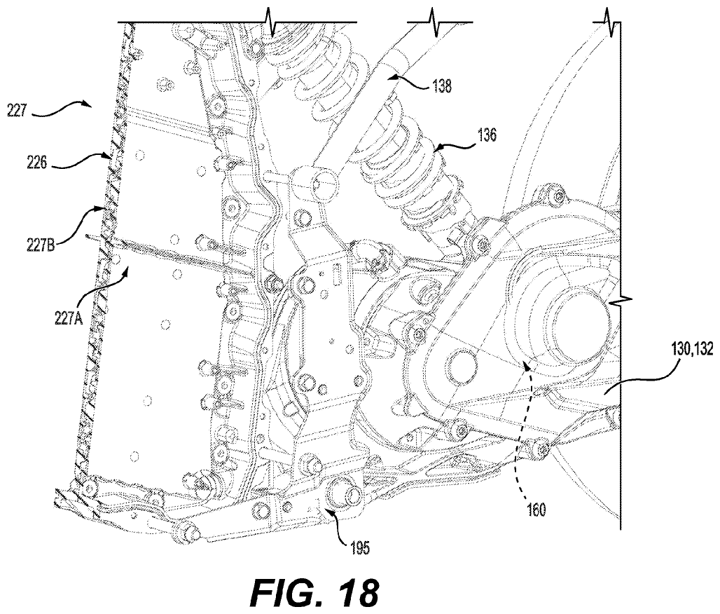

The vehicle 100 also includes two rear brackets 195 connecting the front of the swing arm 132 to the battery pack 210, also referred to as rear mechanical fuses 195. The brackets 195 are fastened (bolted) to the cooling plate 227 (FIG. 18), through the covers 221, 223 (FIG. 16). The swing arm 132 pivots relative to the brackets 195 and the battery pack 210 about a swing arm pivot axis 133 (FIGS. 10 and 11). A front end connecting portion of the swing arm 132 is connected rearward of the cooling plate 227 and is disposed between the brackets 195, with a bolt extending through one rear bracket 195, the connecting portion of the swing arm 132, and the other rear bracket 195. Specifically, a left rear bracket 195 is at least partially disposed on a left side of the battery pack housing 220, the left side of the swing arm 132 being connected to the left rear bracket 195, and a right rear bracket 195 at least partially disposed on a right side of the battery pack housing 220, the right side of the swing arm 132 being connected to the right rear bracket 195.

As can be seen in FIGS. 15, 16, and 18, the seat frame 138 is also connected to the rear brackets 195. A left portion of the seat frame 138 is connected to an upper portion of the left rear bracket 195 and a right portion of the seat frame 138 is connected to an upper portion of the right rear bracket 195.

The brackets 190, 195 connect the rear suspension assembly 130, as well as portions of the seat frame 138, to the cooling plate 227 and serve as mechanical fuses 190, 195 to aid in protecting the battery pack 210 and the cooling plate 227. The mechanical fuses 190, 195 provide a protective arrangement for the battery pack 210, where excessive loads from the rear suspension assembly 130 or the seat 140 will break the mechanical fuses 190, 195 before damaging the battery pack 210. While the battery pack 210 is configured and arranged to bear mechanical loads during standard use of the vehicle 100, the mechanical fuses 190, 195 serve as designed break points for excessive forces (outside of the range of standard use) as the brackets 190, 195 are more easily and more cheaply replaced than a damaged battery pack 210.

As is illustrated in FIG. 11, the battery pack 210 is a sole structural connection between the front suspension assembly 123 and the rear suspension assembly 130. The battery pack 210 connects the front suspension assembly 123 to the rear suspension assembly 130, with the vehicle 100 having no central frame supporting the battery pack 210, nor any other central components of the vehicle 100.

The vehicle 100 further includes a plurality of body panels 142 for forming the body of the vehicle 100, illustrated in FIGS. 1 to 3. The body panels 142 are connected to and supported by the front bracket 170, the battery pack housing 220, the seat frame 138, and/or the rear suspension assembly 136. The body panels 142 enclose and protect some internal components of the vehicle 100 such as a powerpack 200. The vehicle 100 also includes a front fender 144 disposed at the front of the vehicle 100 and extending partially over the front wheel 121. Rearward of the seat 140, the vehicle 100 also has rear fender panels 146 extending at least partially over rear wheel 127 and supporting the vehicle license plate. The vehicle 100 includes front headlights 145 attached to the front fork assembly 124 and electrically connected to the battery pack 210. The vehicle 100 also has rear braking and indicator lights 147 supported by the rear panels 146 and electrically connected to the battery pack 210.

Depending on the particular embodiment, especially between different motorcycle types (trail-style motorcycle or street-style motorcycle for example), the body panels 142 and the fenders 144, 146 could be different in shape and number. For example, some embodiments of the vehicle 100 could include a mud flap connected to a rear edge of one of the body panels 142. It is further contemplated that one or both of the fenders 144 and rear panels 146 could be omitted in some cases.

A driver footrest 126 is disposed on either side of the vehicle 100 and vertically lower than the straddle seat 140 to support the driver's feet. The driver footrests 126 are connected to the rear 195 brackets. It is contemplated that the footrests 126 could be connected to different components in some embodiments. It is contemplated that the footrests 126 could be implemented in various forms other than those illustrated, including but not limited to pegs and footboards. It is contemplated that the vehicle 100 could also be provided with one or more passenger footrests disposed rearward of the driver footrest 126 on each side of the vehicle 100, for supporting a passenger's feet when a passenger seat portion for accommodating a passenger is connected to the vehicle 100. A brake pedal 128 is connected to the right driver footrest 126 for braking the vehicle 100. The brake pedal 128 is disposed forward of the right driver footrest 126 such that the driver can actuate the brake pedal 128 with a front portion of the right foot while a rear portion of the right foot remains on the right driver footrest 126.

As is seen in FIG. 1, each of the front wheel 121 and the rear wheel 127 is provided with a brake assembly 90. The brake assemblies 90 of the wheels 121, 127, along with the brake pedal 128, form part of a brake system 92. Each brake assembly 90 is a disc-type brake mounted onto the spindle of the respective wheel 121 or 127. Other types of brakes are contemplated. The brake pedal 128, as well as the brake lever 155, are operatively connected to the brake assemblies 90 provided on each of the front wheel 121 and the rear wheel 127. The brake system 92 further includes a regenerative braking system (not shown) that uses the electric motor 160 as a generator to charge battery cells 230 of the battery pack 210 while slowing the vehicle 100.

It is contemplated that the vehicle 100 could include a variety of different features excluded from discussion here, including but not limited to: a windscreen, radio and/or navigational systems, and luggage rack systems.

The vehicle 100 implemented in accordance with some non-limiting implementations of the present technology can be represented as follows, presented in numbered clauses.

CLAUSE 1. A vehicle (100) comprising:
a battery pack (210) comprising a battery pack housing (220), the battery pack housing comprising:
at least one cooling plate (227), and
at least one pack cover connected to the at least one cooling plate;
at least one front wheel (121) rotationally connected to the battery pack housing;
at least one rear wheel (127) rotationally connected to the battery pack housing;
a straddle seat (140) connected to the battery pack housing;
a steering assembly (151) operatively connected to the at least one front wheel; and
an electric motor (160) operatively connected to at least one of the at least one front wheel and the at least one rear wheel, the electric motor being operatively connected to the battery pack for receiving power therefrom,
the battery pack housing being a structural element of the vehicle for receiving loads from at least two of:
   the at least one front wheel,
   the at least one rear wheel,
   the straddle seat, and
   the steering assembly.

CLAUSE 2. The vehicle of clause 1, wherein the at least one cooling plate is configured and arranged for receiving loads from at least two of:
the at least one front wheel,
the at least one rear wheel,
the straddle seat, and
the steering assembly.

CLAUSE 3. The vehicle of clause 1 or 2, further comprising:
a front suspension bracket (170) connected to and supported by the battery pack housing; and
a front suspension assembly connected to and supported by the front suspension bracket, the at least one front wheel being rotationally connected to the front suspension assembly.

CLAUSE 4. The vehicle of clause 3, wherein:
the front suspension bracket includes a head tube (172); and
the front suspension assembly includes a front fork assembly rotationally connected through the head tube.

CLAUSE 5. The vehicle of clause 3 or 4, wherein the front suspension bracket is fastened to the at least one cooling plate.

CLAUSE 6. The vehicle of clause 4, wherein:
the steering assembly includes a handlebar connected to the front fork assembly;
the front fork assembly includes a triple clamp assembly;
the triple clamp assembly extends through the head tube; and
the handlebar is connected to the triple clamp assembly for steering the vehicle.

CLAUSE 7. The vehicle of any one of clauses 1 to 6, further comprising a seat frame (138) connected to the battery pack housing, the straddle seat being connected to and supported by the seat frame.

CLAUSE 8. The vehicle of clause 7, wherein the seat frame is fastened to the at least one cooling plate.

CLAUSE 9. The vehicle of any one of clause 1 to 8, further comprising:
a rear suspension assembly (130) connected to the battery pack housing,
the at least one rear wheel being rotationally connected to the rear suspension assembly.

CLAUSE 10. The vehicle of clause 9, further comprising at least one rear bracket (195) connected to the battery pack housing, at least a portion of the rear suspension assembly being pivotally connected to the at least one rear bracket.

CLAUSE 11. The vehicle of clause 10, wherein the at least one rear bracket includes at least one rear mechanical fuse (195).

CLAUSE 12. The vehicle of clause 9, further comprising:
a front suspension bracket connected to and supported by the battery pack housing; and
a front suspension assembly connected to and supported by the front suspension bracket, the at least one front wheel being rotationally connected to the front suspension assembly.

CLAUSE 13. The vehicle of clause 12, wherein the battery pack housing is a sole structural connection between the front suspension assembly and the rear suspension assembly.

CLAUSE 14. The vehicle of clause 12, wherein the battery pack housing connects the front suspension assembly to the rear suspension assembly.

CLAUSE 15. The vehicle of any one of clauses 9 to 14, wherein the rear suspension assembly comprises:
a swing arm (132) pivotally connected to the battery pack housing; and
a shock absorber (136) pivotally connected to the swing arm at a first end, a second end of the shock absorber being pivotally connected to the battery pack housing.

CLAUSE 16. The vehicle of clause 15, further comprising at least one shock bracket (190) fastened to the at least one cooling plate, the second end of the shock absorber being pivotally connected to the at least one shock bracket.

CLAUSE 17. The vehicle of clause 16, wherein the at least one shock bracket is at least one shock mechanical fuse (190).

CLAUSE 18. The vehicle of any one of clauses 15 to 17, further comprising at least one rear bracket connected to the battery pack housing, a front end of the swing arm being pivotally connected to the at least one rear bracket.

CLAUSE 19. The vehicle of clause 18, wherein:
the at least one rear bracket includes:
a left rear mechanical fuse at least partially disposed on a left side of the battery pack housing, and
a right rear mechanical fuse at least partially disposed on a right side of the battery pack housing;
a left side of the swing arm is connected to the left rear mechanical fuse; and
a right side of the swing arm is connected to the right rear mechanical fuse.

CLAUSE 20. The vehicle of clause 18, wherein:
the at least one rear bracket includes at least one mechanical fuse; and
the motor is disposed in the swing arm, the motor being supported by the battery pack housing via the at least one rear mechanical fuse.

CLAUSE 21. The vehicle of any one of clauses 18 to 20, further comprising a seat frame connected to the battery pack housing and the at least one rear bracket, the straddle seat being connected to and supported by the seat frame.

CLAUSE 22. The vehicle of clause 21, wherein:
the at least one rear bracket includes:
a left rear mechanical fuse at least partially disposed on a left side of the battery pack housing, and
a right rear mechanical fuse at least partially disposed on a right side of the battery pack housing;
the seat frame includes:
   a left seat frame portion, and
   a right seat frame portion;
   the left seat frame portion is connected to the left rear mechanical fuse; and the right seat frame portion is connected to the right rear mechanical fuse.

CLAUSE 23. The vehicle of any one of clauses 1 to 22, wherein:
the at least one cooling plate includes a first cooling plate portion and a second cooling plate portion connected together; and
at least one cooling channel (226) is defined between the first cooling plate portion and the second cooling plate portion, the at least one cooling channel being configured to receive therein a coolant fluid.

CLAUSE 24. The vehicle of clause 23, wherein the at least one pack cover includes:
a first cover connected to the first cooling plate portion; and
a second cover connected to the second cooling plate portion.

CLAUSE 25. The vehicle of clause 23 or 24, further comprising a fluid cooling system including:
a fluid pump;
a coolant fluid reservoir; and
a cooling circuit formed at least in part by the at least one cooling channel of the battery pack housing, the at least one cooling channel being fluidly connected to the fluid pump and the coolant fluid reservoir.

CLAUSE 26. The vehicle of any one of clauses 1 to 25, wherein the battery pack further comprises a plurality of battery cells disposed in the battery pack housing, the plurality of battery cells being disposed in thermal communication with the at least one cooling plate.

CLAUSE 27. The vehicle of any one of clauses 1 to 26, wherein:
a top most point of the battery pack housing is vertically higher than the at least one front wheel and the at least one rear wheel; and
a bottom most point of the battery pack housing is vertically lower than a rotation axis of the at least one front wheel and a rotation axis of the at least one rear wheel.

CLAUSE 28. The vehicle of any one of clauses 1 to 27, wherein the battery pack housing is disposed longitudinally between the at least one front wheel and the at least one rear wheel.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A vehicle comprising:
a battery pack comprising a battery pack housing, the battery pack housing comprising:
at least one cooling plate, and
at least one pack cover connected to the at least one cooling plate;
at least one front wheel rotationally connected to the battery pack housing;
at least one rear wheel rotationally connected to the battery pack housing;
a straddle seat connected to the battery pack housing;
a steering assembly operatively connected to the at least one front wheel; and
an electric motor operatively connected to at least one of the at least one front wheel and the at least one rear wheel, the electric motor being operatively connected to the battery pack for receiving power therefrom,
the battery pack housing being a structural element of the vehicle for receiving loads from at least two of:
the at least one front wheel,
the at least one rear wheel,
the straddle seat, and
the steering assembly.

2. The vehicle of claim 1, wherein the at least one cooling plate is configured and arranged for receiving loads from at least two of:
the at least one front wheel,
the at least one rear wheel,
the straddle seat, and
the steering assembly.

3. The vehicle of claim 1, further comprising:
a front suspension bracket connected to and supported by the battery pack housing; and
a front suspension assembly connected to and supported by the front suspension bracket, the at least one front wheel being rotationally connected to the front suspension assembly.

4. (canceled)

5. The vehicle of claim 3, wherein the front suspension bracket is fastened to the at least one cooling plate.

6. (canceled)

7. The vehicle of claim 1, further comprising a seat frame connected to the battery pack housing, the straddle seat being connected to and supported by the seat frame.

8. The vehicle of claim 7, wherein the seat frame is fastened to the at least one cooling plate.

9. The vehicle of claim 1, further comprising:
a rear suspension assembly connected to the battery pack housing,
the at least one rear wheel being rotationally connected to the rear suspension assembly.

10. The vehicle of claim 9, further comprising at least one rear bracket connected to the battery pack housing, at least a portion of the rear suspension assembly being pivotally connected to the at least one rear bracket.

11. The vehicle of claim 10, wherein the at least one rear bracket includes at least one rear mechanical fuse.

12-15. (canceled)

16. The vehicle of claim 9, wherein the rear suspension assembly comprises:
a swing arm pivotally connected to the battery pack housing; and
a shock absorber pivotally connected to the swing arm at a first end, a second end of the shock absorber being pivotally connected to the battery pack housing; and
further comprising at least one shock bracket fastened to the at least one cooling plate, the second end of the shock absorber being pivotally connected to the at least one shock bracket.

17. The vehicle of claim 16, wherein the at least one shock bracket is at least one shock mechanical fuse.

18. (canceled)

19. The vehicle of claim 9, wherein the rear suspension assembly comprises:
a swing arm pivotally connected to the battery pack housing;
a shock absorber pivotally connected to the swing arm at a first end, a second end of the shock absorber being pivotally connected to the battery pack housing; and
further comprising at least one rear bracket connected to the battery pack housing, a front end of the swing arm being pivotally connected to the at least one rear bracket; and wherein:
the at least one rear bracket includes:
a left rear mechanical fuse at least partially disposed on a left side of the battery pack housing, and
a right rear mechanical fuse at least partially disposed on a right side of the battery pack housing;
a left side of the swing arm is connected to the left rear mechanical fuse; and
a right side of the swing arm is connected to the right rear mechanical fuse.

20. The vehicle of claim 9, wherein the rear suspension assembly comprises:
a swing arm pivotally connected to the battery pack housing;
a shock absorber pivotally connected to the swing arm at a first end, a second end of the shock absorber being pivotally connected to the battery pack housing; and
further comprising at least one rear bracket connected to the battery pack housing, a front end of the swing arm being pivotally connected to the at least one rear bracket; and wherein:
the at least one rear bracket includes at least one mechanical fuse; and
the motor is disposed in the swing arm, the motor being supported by the battery pack housing via the at least one rear mechanical fuse.

21. The vehicle of claim 9, wherein the rear suspension assembly comprises:
a swing arm pivotally connected to the battery pack housing; and
a shock absorber pivotally connected to the swing arm at a first end, a second end of the shock absorber being pivotally connected to the battery pack housing; and
further comprising:
at least one rear bracket connected to the battery pack housing, a front end of the swing arm being pivotally connected to the at least one rear bracket; and
a seat frame connected to the battery pack housing and the at least one rear bracket, the straddle seat being connected to and supported by the seat frame.

22. The vehicle of claim 21, wherein:
the at least one rear bracket includes:
a left rear mechanical fuse at least partially disposed on a left side of the battery pack housing, and a right rear mechanical fuse at least partially disposed on a right side of the battery pack housing;
the seat frame includes:
a left seat frame portion, and
a right seat frame portion;
the left seat frame portion is connected to the left rear mechanical fuse; and
the right seat frame portion is connected to the right rear mechanical fuse.

23. The vehicle of claim 1, wherein:
the at least one cooling plate includes a first cooling plate portion and a second cooling plate portion connected together; and
at least one cooling channel is defined between the first cooling plate portion and the second cooling plate portion, the at least one cooling channel being configured to receive therein a coolant fluid.

24. The vehicle of claim 23, wherein the at least one pack cover includes:
a first cover connected to the first cooling plate portion; and
a second cover connected to the second cooling plate portion.

25. The vehicle of claim 23, further comprising a fluid cooling system including:
a fluid pump;
a coolant fluid reservoir; and
a cooling circuit formed at least in part by the at least one cooling channel of the battery pack housing, the at least one cooling channel being fluidly connected to the fluid pump and the coolant fluid reservoir.

26. The vehicle of claim 1, wherein the battery pack further comprises a plurality of battery cells disposed in the battery pack housing, the plurality of battery cells being disposed in thermal communication with the at least one cooling plate.

27. The vehicle of claim 1, wherein:
a top most point of the battery pack housing is vertically higher than the at least one front wheel and the at least one rear wheel; and
a bottom most point of the battery pack housing is vertically lower than a rotation axis of the at least one front wheel and a rotation axis of the at least one rear wheel.

28. (canceled)
